(19) United States
(12) Patent Application Publication
(10) Pub. No.: US 2025/0066617 A1
(43) Pub. Date: Feb. 27, 2025

(54) Suspension for preserving masonry structures for consolidation, weather-resistance, water-repellent, stain-resistance, fungal-resistance and self-cleaning, and a method for applying the suspension on porous surfaces of structures, especially on historical building materials

(71) Applicants: Hamed NIROUMAND, Tehran (IR); Lech Balachowski, Gdansk (PL); Maryam Afsharpour, Tehran (IR)

(72) Inventors: Hamed NIROUMAND, Tehran (IR); Lech Balachowski, Gdansk (PL); Maryam Afsharpour, Tehran (IR)

(21) Appl. No.: 18/237,400

(22) Filed: Aug. 23, 2023

(51) Int. Cl. C09D 5/02; C09D 7/20; C09D 7/40; C09D 7/61; C09D 7/65

(52) U.S. Cl. CPC C09D 5/028; C09D 5/022; C09D 7/20; C09D 7/61; C09D 7/65; C09D 7/67

(57) ABSTRACT

A suspension for preserving masonry structures comprises a hydrophobic agent, water-repellent nanoparticles, a nanofiller, a self-cleaning agent, a vegetable oil, a first solvent and water. The water-repellent nanoparticles, the hydrophobic agent, the nanofiller, the self-cleaning agent and the vegetable oil are mixed with the first solvent and water, and are dispersed in a form of a nanocomposite suspension. A method for preserving masonry structures, especially surfaces of historical building materials as a substrate by using a multi-functional nanocomposite suspension, to increase the structures' life, improving weather-resistance and/or water-repellent and/or stain-resistance and/or fungal-resistance and/or self-cleaning. The suspension is prepared by mixing a water-repellent nanoparticles, at least one silicon-based hydrophobic polymer as a hydrophobic agent, a nanofiller, and/or a nano-additive as a self-cleaning agent, a vegetable oil, a first solvent and water. An ultrasonic homogenizer is used to disperse the nanoparticles onto the nanocomposite suspension consisting of nanoparticles.

### BACKGROUND OF THE INVENTION

### Field of the Invention

The present disclosure generally relates to materials engineering, and more particularly to a suspension for preserving masonry structures for consolidation, weather-resistance, water-repellent, stain-resistance, fungal-resistance and self-cleaning, and a method for applying the suspension on porous surfaces of structures, especially on historical building materials. The suspension is a heterogeneous mixture in which the solid particles do not dissolve, but get suspended throughout the bulk of the solvent, left floating around freely in the medium. The internal phase (solid) is dispersed throughout the external phase (fluid) through mechanical agitation, with the use of certain excipients or suspending agents.

### Brief Description of the Background of the Invention Including Prior Art

Adobe, brick, and stone are widely used as construction materials for buildings, especially for historical buildings. External surfaces of these structures are subject to erosion and damages due to many causes, such as moisture, acid rain, salts, mold and fungal growth, water and wind erosion, ice or chilled water damage, extreme temperatures, and various pollutants in the atmosphere. They also crack due to the tensile and compressive stresses. Since masonry materials are non-homogeneous compounds and due to their permeability and penetrability, the increase in environmental pollution along with the weathering process, changes the structure of their raw materials, occurring the surface damage, especially at joints with mortar. Reducing the water penetration and ions permeability, while increasing the mechanical resistance by filling the cracks and holes can increase the lifetime of the structure. So, there is a need for a proper moisture-resistance, waterproofing, antifungal, and consolidation materials to preserve the historical building materials from different damages.

The selected materials need to have long-term preservation effects and they don't have caused any harm for structure. In recent methods, the water-proofing materials and paints applied to structures by brush, spray or roll-on methods which create an insufficient coat with low penetration. Using the second coat tends to fill the breathing passages, which cause cracks and delimitations due to the internal thermal stresses.

Document CA2018325A1 discloses a method for preserving porous structures, including masonry structures having embedded structural or reinforcing steel rods, applies liquid preservative material to an exposed surface of the structure and injects the material into the structure using the blasting force of a compressed air stream at high velocity. The apparatus for practicing the method includes separate manifolds having multiple outlet nozzles provided for the liquid material and for the air streams, both manifolds covered by a shroud. The manifolds and their nozzles are arranged so that, as the liquid is applied to the surface of the structure, the high velocity air forces or injects it into the interior of the structure, so as to coat the interstices of the inner porous structure including any reinforcing steel therein, the high velocity air streams acting as a fluid hammer. The preservation of the structures occurs without the need of disturbing, breaking open or repairing brick, concrete or masonry structures. However, even with a high pressure air stream used for the dispersion of the coating composition, the resulting coating may suffer from uneven distribution of the particle sizes, due to the chaotic nature of the atomization process using an air jet method. In this invention, liquid preservative material consists of polymers acrylic and epoxy resins, polyurethanes, silane polymers and petroleum hydrocarbons.

Document KR101049032B1 discloses a method for protecting the surface of a concrete structure and expanding the life expectancy of the concrete structure using a complex coating structure provided to increase the durability and prevent the neutralization of the concrete structure. The coating structure comprises a permeable primer (3), including 70-80 weight % of a resin, 10-15 weight % of a coloring pigment, 5-10 weight % of a different pigment, and 1-5 weight % of admixture. The resin is obtained by mixing the 75:3 weight ratio of an acryl emulsion resin and a silicon resin. The permeable primer is applied to the surface of a concrete structure. A water-soluble primer (2) includes 60-70 weight % of a resin, 10-15 weight % of the coloring pigment, 15-20 weight % of a different pigment, and 1-5 weight % of the admixture. The resin is obtained by mixing the 65:3 weight ratio of the acryl emulsion resin and the silicon resin. The water-soluble primer is applied on the permeable primer. An upper coat (1) includes 30-45 weight % of a flame retardant resin, 10-15 weight % of the coloring pigment, 40-50 weight % of the different pigment, and 1-5 weight % of the admixture. The flame retardant resin includes 12:25:2 weight ratio of an inorganic binder, the acryl emulsion resin, and the silicon resin. The upper coat is applied on the water-soluble primer. While the resin constituent of the composition provide a high level of protection from most of the environmental factors, the particle size of the resulting composition is limited and may not penetrate the finest pores of the material of the subject surface.

Document CN101500965A discloses a method for impregnation of porous objects comprising the following steps i)-v): i) applying an injection layer of a material comprising acrylic, epoxy or polyurethane onto the surface of at least part of the porous object and allowing at least part of said material to enter into the pores of said object utilizing subatmospheric or superatmospheric pressure; ii) allowing the porous object to return to an atmosphere of normal pressure; iii) optionally at least partly allowing the injection layer to harden; iv) applying a topcoat of acrylic, epoxy or polyurethane onto the area of the porous object impregnated with the injection layer: v) allowing the topcoat to harden; wherein the injection layer applied in step i) and/or the topcoat applied in step iv) comprises pulverized glass having a particle size of 0 nm to 100 [mu]m. The invention also relates to porous objects obtained according to this method. The impregnated objects exhibits great strengths and resistance against wear of mechanical, chemical, thermal and/or biological nature. This invention, while providing innovative additions to the standard coating process, also suffers from the same disadvantage of using a input material of a particle size not small enough to enter the finest pores of the material to be coated. Furthermore, in all of the mentioned inventions, polymers have been used to achieve the desired properties, which, in addition to weakness of insufficient coating with low penetration, reduce the breathability by filling the breathing passages which cause cracks and delimitations due to the internal thermal stresses. Also, organic polymers do not have high stability in the presence of light, temperature, and humidity, and their properties change over a long period of time. So, that is not suitable for historical buildings.

There are very limited reports on the protective coatings of historical buildings. Document KR102128409B1 discloses a composition for preservation and treatment of stone cultural properties and a method for preservation and treatment of stone cultural properties using the same. The composition for preservation and treatment of stone cultural properties of the present invention comprises: 33.8 wt % of an magnesium phosphate-based inorganic binder; 1 wt % of a silane-siloxane-based powder water repellent; 4 wt % latex resin; and the remainder consisting of mineral filler (silica fume, silica sand, and granite powder). According to the present invention, the composition is composed of the inorganic binder and the inorganic filler, but by adding a water repellent in a specific ratio, it is possible to suppress whitening while minimizing strength reduction. By adding stone powder of the same quality as the cultural properties to the inorganic filler, the adhesion can be improved and the difference in color can be minimized. A small amount of latex is added to the composition, so that adhesion can be excellent in areas where the repair area is thin. However, such a composition, while preserving the stone material from some of the atmospheric and environmental factors (water, whitening), does not provide protection from other degradation processes. Also, the depth of penetration is low due to the size of solid fillers, so, this preservative coating which is used for historiacal stone is not proper for highly porous building materials such as adobe and brick. Inventions known from the prior art provide only limited protection of surfaces of masonry structures. Therefore there is a need for a product which provides higher level of more complete protection of said structures, especially surfaces of historical building materials.

### SUMMARY OF INVENTION

In the present invention there is provided a suspension for preserving masonry structures. The suspension according to the invention comprises at least one hydrophobic agent, water-repellent nanoparticles, a nanofiller, a self-cleaning agent, a vegetable oil, a first solvent and water. According to the invention the suspension (also called a composition or composition of preservative nanocomposite) is composed of the following ingredients: the water-repellent nanoparticles, the hydrophobic agent, one nanofiller, the self-cleaning agent, and the vegetable oil, which are mixed with the first solvent and water, and are dispersed in a form of a nanocomposite suspension.

Nanoparticles are generally defined as particles of material that is between 1 and 100 nanometers in size. Nanocomposite is a multiphase solid material where one of the phases has material with one, two or three dimensions of less than 100 nanometers (nm). Additional information about the preservative roles of each component in the presented nanocomposites in historical building materials is provided below:
Silicon-based polymers: These silicon-based polymers include silane, silanol, siloxane precursors, or a derivative thereof. These polymers are hydrophobic in nature and are used to form the water-repellent surface. Their structure is made of silica and is consistent with the ingredients of building materials, so no destructive interaction occurs. It is a suitable base for dispersing nanofillers and nanoadditives, and by penetrating into the holes and cracks, it can increase the strength of the building materials. After drying, a thin layer of silica particles are placed on external and internal surfaces in the form of silica and do not cause any problems for the breathability of the building.
Water-repellent additive: Various forms of nanostructured silica are used as the water-repellent additive, including silica nanoparticles, silica foam, natural nanoporous silica (diatomaceos earth or perlite). These water-repellent additives are useful to form the water-resistance surface and also can fill the pores and cracks to increase the strength of building materials. The nano-size of these materials increases the permeability into the porous texture of adobe or brick and causes a deeper effect. Therefore, the spray method is effective.
Nanofillers: Various nanoclays are used as nanofillers, including montmorillonite, bentonite, and kaolinite nanoclays. Clay is a material that is used in construction materials, so no destructive interactions occur in the future. On the other hand, the small size of the nanoclay particles helps the materials to penetrate well into the holes and increase the strength of the building. Filling the holes also reduces water permeability.
Self-cleaning agent: nano-additives including titanium dioxide nanoparticles and zinc oxide nanoparticles are used as the self-cleaning agent, the UV-blocking agent, and the antifungal agent. These inorganic materials can adsorb the UV light and produce the oxygenated radicals that can remove the surface pollutants such as greasy or colored pollutants and also can purify the air pollutants. They can also prevent the growth of fungi, bacteria, and algae on the surface. No destructive reaction occurs between these inorganic compounds and building materials that are made of aluminosilicates. There are often small amounts of these inorganic compounds in the soil composition.
Vegetable oil: Various vegetable oil types including linseed oil, soybean oil, olive oil, sunflower oil, thyme oil, oregano oil and clove oil are used in order to form the water-resistance surface. Some of this oil types are also useful to prevent the growth of microorganisms.

Preferably, depend on desired properties, the suspension comprises 5-30 vol %, more preferably 10-20 vol % of the hydrophobic agent, 1-10 wt %, more preferably 2-3 wt % of the water-repellent nanoparticles, 1-10 wt %, more preferably 2-3 wt % of the nanofillers, 1-5 wt %, more preferably 1-3 wt % of the self-cleaning agent, 5-20 wt %, more preferably 8-10 wt % of the vegetable oil, 10-30 vol %, more preferably 10-20 vol % of water and 70-90 vol %, more preferably 80-90 vol % of the first solvent.

Preferably, the water-repellent nanoparticles includes silica nanoparticles with a particle size of 40-90 nm and a specific surface area of 300-350 m²/g and/or silica foam with a specific surface area of 160-240 m²/g and/or natural nanoporous silica, including diatomaceos earth or perlite.

The specific surface area (SSA) was measured by N₂ adsorption-desorption isotherm (Brunauer-Emmett-Teller, BET analysis). Nitrogen adsorption is a useful technique to characterize the porous materials. In this method, the adsorption-desorption of nitrogen in the external and internal surface of materials is determined over the range of relative pressure at low temperature. BET ((Brunauer-Emmett-Teller) model is used to determine the surface area, and BJH (Barrett-Joyner-Halenda) model is used to analyze the pore size distribution in porous materials. This technique is a common and well-known method for the person skilled in the art.

Preferably, the silica nanoparticles have a particle size of 40-90 nm and a specific surface area of 300-350 m²/g and/or the silica foam has a specific surface area of 160-240 m²/g and/or is a natural nanoporous silica.

Preferably, the natural nanoporous silica includes diatomaceos earth including 93-98% of silicon and having 87-93% porosity and/or perlite including 75-90% of silicon and having 70-85% porosity.

Porosity is a measure of the void or pore spaces in a material, and is a fraction of the volume of voids or pores over the total volume of the material.

Preferably, the hydrophobic agent is comprising at least one silicon-based hydrophobic polymer.

Preferably, the silicon-based hydrophobic polymer includes a silane, and/or silanol and/or siloxane precursors, or a derivative thereof.

Preferably, the silicon-based hydrophobic polymer is selected from a group including polydimethylsiloxane with 20-15000 MPas·s viscosity, tetramethoxysilane, tetraethoxysilane, trimethoxymethylsilane, triethoxymethylsilane, triethoxyethylsilane, dimethoxydimethylsilane, dimethoxydiethylsilane, diethoxydiethylsilane, aminopropyltrimethoxysilylane, trimethylsilanol, triethylsilanol, tris(tert-butoxy)silanol, and sodium silicate.

Preferably, as the first solvent is used at least one alcohol, including ethanol and/or propanol and/or isopropanol and/or n-butanol and/or isobutanol or a mixture thereof.

Preferably, the nanofillers have a particle size of 1-10 nm and a specific surface area of 120-270 m²/g, and include montmorillonite and/or bentonite and/or kaolinite nanoclays.

Preferably, the nano-additive as the self-cleaning agent has a particle size of 5-50 nm and a specific surface area of 25-250 m²/g, and includes titanium dioxide and zinc oxide nanoparticles.

Preferably, the vegetable oil includes linseed oil and/or soybean oil and/or olive oil and/or sunflower oil and/or thyme oil and/or oregano oil and/or clove oil.

The present invention also provides a method for preserving masonry structures, especially surfaces of historical building materials as a substrate, by using a multi-functional nanocomposite suspension, to increase the structures' life, improving weather-resistance and/or water-repellent and/or stain-resistance and/or fungal-resistance and/or self-cleaning. The method comprises the steps of:
a) selecting a structure with the substrate to be coated, wherein the substrate is a porous material;
b) preparing a suspension, wherein the suspension is prepared by mixing the following components: a water-repellent nanoparticles, at least one silicon-based hydrophobic polymer as a hydrophobic agent, a nanofiller, a nano-additive as a self-cleaning agent, a vegetable oil, a first solvent and water;
c) utilizing an ultrasonic homogenizer to disperse said components onto the nanocomposite suspension consisting of nanoparticles;
d) applying the nanocomposite suspension on the substrate at least once; and/or
e) utilizing the nanocomposite suspension to coat the substrate by using a simple spray method and/or using a blast of compressed air for a better penetration of the nanocomposite suspension into the substrate.

Porous material is a solid material containing a plurality of pores, including cavities and/or channels and/or interstices and/or holes of different sizes from 1 millimeter to 1 nanometer.

Preferably, said surfaces of the historical building materials such as adobe, brick, stone, and mortar are selected as porous materials with aluminosilicate structures.

The method which is proposed in this invention is the use of multipurpose nanocomposites for multi-functional protection of masonry materials of buildings, especially historical buildings and/or monuments. In addition to strengthening the structure and filling cracks and holes, these materials can protect the structure against atmospheric factors such as humidity, rain and snow, temperature changes, stain, air pollutants, and fungi and algae. So, the ability of using the hydrophobic agent in combination with other nano-additives to inhibit or decrease the damages from weathering, atmospheric pollutants, fungal or algae, and subsequent degradation was discussed.

### BRIEF DESCRIPTION OF THE DRAWINGS

To complete understanding and showing the advantages of the present disclosure, figures are added to describe the specific embodiments of the disclosure, wherein:

FIGS. 1a-1f show SEM images: of untreated adobe (FIG. 1a), untreated brick (FIG. 1b), untreated mortar (FIG. 1c), and treated adobe (FIG. 1d), treated brick (FIG. 1e), treated mortar (FIG. 1f) with a multi-functional agent, where the filling of cracks and pores can be clearly seen after the applying of the coating by two-times spraying of nanocomposite suspension.

FIGS. 2a-2b. show: the contact angles of water drop on the surface of untreated adobe (FIG. 2a) and treated adobe (FIG. 2b).

FIGS. 3a-3d show: the results of fall simulator rain on the Untreated Sample before (FIG. 3a) and after (FIG. 3b) test, and the results of fall simulator rain on the Treated Sample before (FIG. 3c) and after (FIG. 3d) test.

FIGS. 4a-4d show: the results of freezing on the Untreated sample before (FIG. 4a) and after (FIG. 4b) test, and the results of freezing on the Treated sample before (FIG. 4c) and after (FIG. 4d) test.

FIGS. 5a-5d show: the SEM images of the Untreated Sample (FIG. 5a) and Treated Sample (FIG. 5b) after fall simulator rain test, and the SEM images of the Untreated Sample (FIG. 5c) and Treated Sample (FIG. 5d) after freezing test.

FIG. 6 shows the self-cleaning effect of nano-additives to remove the stains on the surface of coated stone.

FIGS. 7a-7c show: the images of historical building samples to preserve their adobe (FIG. 7a), brick (FIG. 7b), and mortar (FIG. 7c) materials.

### DETAILED DESCRIPTION OF INVENTION AND PREFERRED EMBODIMENT

The following examples are included to represent illustrative embodiments of the disclosure.

### Example 1

The following describes the nanocomposite suspension preparation and coating procedures for preserving the historical building materials to increase the mechanical strength and filling the cracks and pores. The nanocomposite suspension is a mixture of at least one solid nanomaterial (material with the average size of the particles from 1 nm to 100 nm) which are dispersed in solvents and/or mixture of at least one hydrophobic polymer with solvents. In this description the term “solvents” means the first solvent and water.
Sample 1: A nanocomposite suspension comprising a mixture of 1.2 g nanofiller (bentonite nanoclay) in 100 mL solvents (water and ethanol with 1:9 ratio) were prepared by mixing the above components under sonication (100 W, 10 min, room temperature). The resulting suspension was used to treat adobe by spraying on the surface 2 times. The panels were dried before repeat the spray.
Sample 2: A nanocomposite suspension, comprising a mixture of 10 mL silicon based hydrophobic polymer (tetraethyl orthosilicate), 1.2 g nanofiller (bentonite nanoclay), and 100 mL solvents (water and ethanol with 1:9 ratio), was prepared by mixing the dispersed nano suspension (according to sample 1) with polymer-based solution under sonication. (50 mL of mixture of solvents was used for dispersion of nanofiller and 50 mL was used for dissolve the tetraethyl orthosilicate.) The resulting suspension was used to treat adobe by spraying on the surface 2 times. The panels were dried before repeat the spray.
Sample 3: A nanocomposite suspension, comprising a mixture of 10 mL silicon-based hydrophobic polymer (tetraethyl orthosilicate and polydimethylsiloxane with 1:1 ratio), 1.2 g nanofiller (bentonite nanoclay), 90 mL first solvent (ethanol) and 10 ml water, was prepared by mixing the dispersed nano suspension with polymer-based solution under sonication (according to sample 2). The resulting suspension was used to treat adobe by spraying on the surface 2 times. The panels were dried before repeat the spray.
Sample 4: A suspension, comprising a mixture of 10 mL silicon-based hydrophobic polymer (tetraethyl orthosilicate and polydimethylsiloxane with 1:1 ratio), 1.5 g nanofiller (1.2 g bentonite nanoclay and 0.3 g silica nanoparticles), 90 mL first solvent (ethanol) and 10 ml water, was prepared by mixing the dispersed nano suspensions with polymer-based solution under sonication. The resulting suspension was used to treat adobe by spraying on the surface 2 times. The panels were dried before repeat the spray.

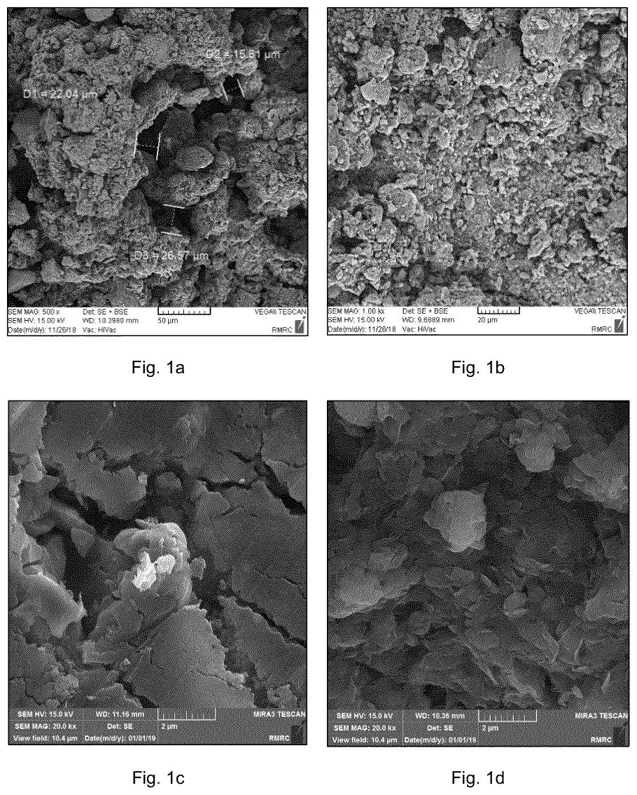

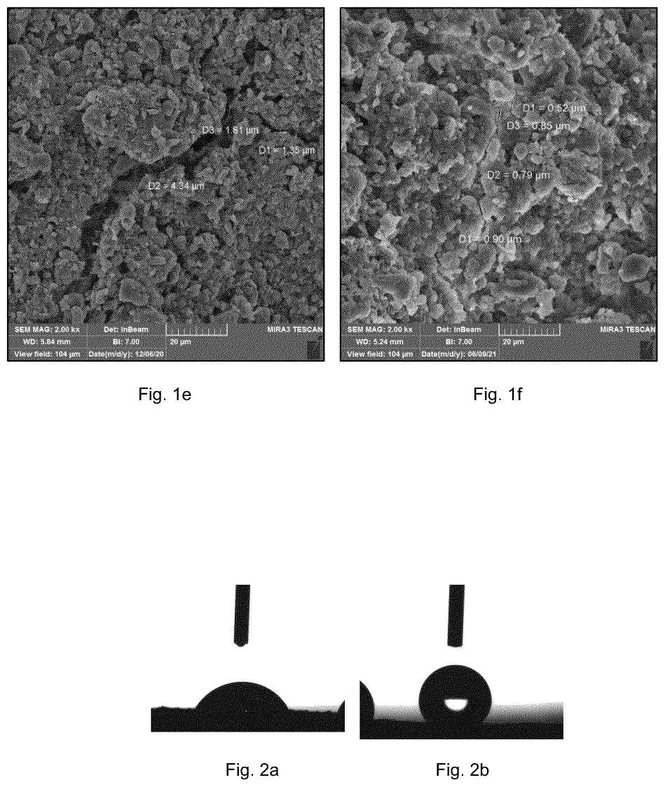

The results of mechanical strengths of the samples were recorded below. FIGS. 1a-1f also show the filling of pores and cracks of building materials in SEM images.

TABLE 1
Results of mechanical strengths of the samples

| | Untreated | Treated | | | |
|---|---|---|---|---|---|
| Sample | Sample | Sample 1 | Sample 2 | Sample 3 | Sample 4 |
| Mechanical | 107.5 | 155.0 | 168.0 | 169.4 | 172.0 |
| Strength | | | | | |

### Example 2

The following describes the nanocomposite suspension preparation and coating procedure for preserving the historical building materials against moisture, rain, and snow.
Sample 1: A solution, comprising a mixture of 10 mL silicon-based hydrophobic polymer (tetraethyl orthosilicate and polydimethylsiloxane with 1:1 ratio), 90 mL first solvent (ethanol) and 10 mL water, was prepared by mixing the above components. The resulting solution was used to treat adobe by spraying on the surface 2 times. The panels were dried before repeat the spray.
Sample 2: A suspension comprising a mixture of 10 mL silicon-based hydrophobic polymer (tetraethyl orthosilicate), 1.2 g water-repellent nanoparticles (diatomaceos earth), 90 mL first solvent (ethanol) and 10 mL water, was prepared by mixing the dispersed nano suspension with polymer-based solution under sonication. The resulting suspension was used to treat adobe by spraying on the surface 2 times. The panels were dried before repeat the spray.
Sample 3: A suspension comprising a mixture of 10 mL silicon-based hydrophobic polymer (tetraethyl orthosilicate and polydimethylsiloxane with 1:1 ratio), 1.2 g water-repellent nanomaterial (diatomaceos earth), 90 mL first solvent (ethanol) and 10 mL water, was prepared by mixing the dispersed nano suspension with polymer-based solution under sonication. The resulting suspension was used to treat adobe by spraying on the surface 2 times. The panels were dried before repeat the spray.
Sample 4: A suspension comprising a mixture of 10 mL silicon-based hydrophobic polymer (tetraethyl orthosilicate and polydimethylsiloxane with 1:1ratio), 1.2 g water-repellent nanomaterial (diatomaceos earth), 0.3 g nanofiller (bentonite nanoclay), 90 mL first solvent (ethanol) and 10 mL water, was prepared by mixing the dispersed nano suspensions with polymer-based solution under sonication. The resulting suspension was used to treat adobe by spraying on the surface 2 times. The panels were dried before repeat the spray.
Sample 5: A suspension comprising a mixture of 10 mL silicon-based hydrophobic polymer (tetraethyl orthosilicate and polydimethylsiloxane with 1:1 ratio), 1.2 g water-repellent nanoparticle (silica nanoparticle), 0.3 g nanofiller (bentonite nanoclay), 90 mL first solvent (ethanol) and 10 ml water, was prepared by mixing the dispersed nano suspensions with polymer-based solution under sonication. The resulting suspension was used to treat adobe by spraying on the surface 2 times. The panels were dried before repeat the spray.
Sample 6: A suspension comprising a mixture of 10 mL silicon-based hydrophobic polymer (tetraethyl orthosilicate and polydimethylsiloxane with 1:1 ratio), 1.2 g water-repellent nanoparticle (silica nanoparticle), 0.3 g nanofiller (bentonite nanoclay), 5 mL vegetable oil (linseed oil), 90 mL first solvent (ethanol) and 10 mL water, was prepared by mixing the dispersed nano suspensions and oil with polymer-based solution under sonication. The resulting suspension was used to treat adobe by spraying on the surface 2 times. The panels were dried before repeat the spray.

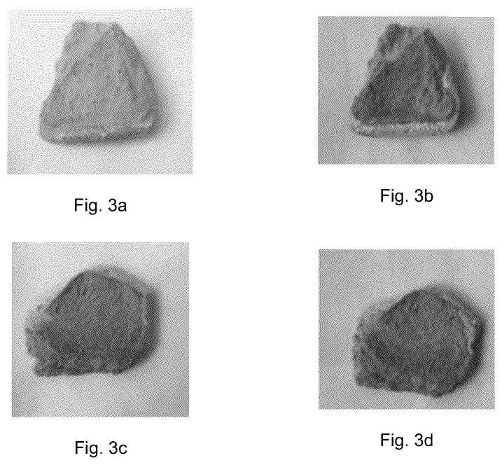

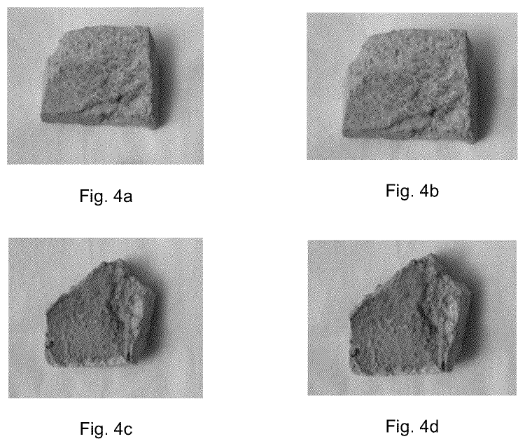

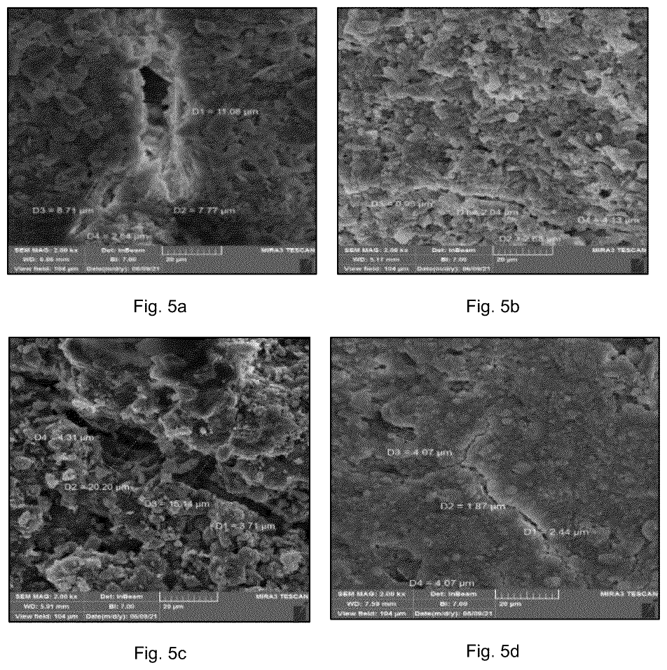

The results of water adsorption percentage after 1 min, 3 days and 7 days were recorded below and the contact angle of water drop, fall simulator rain test and freezing test are also shown in FIGS. 2a-2b, FIGS. 3a-3d, FIGS. 4a-4d and FIGS. 5a-5d.

TABLE 2
Results of water adsorption percentage

| | Sample | | | | | | |
|---|---|---|---|---|---|---|---|
| | | Treated | | | | | |
| | Untreated | Sample | Sample | Sample | Sample | Sample | Sample |
| | Sample | 1 | 2 | 3 | 4 | 5 | 6 |
| 1 min | 100 | 0 | 0 | 0 | 0 | 0 | 0 |
| 3 days | 100 | 26 | 29 | 22 | 11 | 10 | 0 |
| 7 days | 100 | 7 | 12 | 5 | 2 | 2 | 0 |

### Example 3

The following describes the nanocomposite suspension preparation and coating procedure for preserving the historical building materials by removing the stains via self-cleaning coatings.
Sample 1: A suspension comprising a mixture of 1 g self-cleaning agent (titanium dioxide nanoparticles), 90 mL first solvent (ethanol) and 10 mL water, was prepared by mixing the above components under sonication. The resulting suspension was used to treat adobe by spraying on the surface 2 times. The panels were dried before repeat the spray.
Sample 2: A suspension comprising a mixture of 1 g nanofiller (bentonite nanoclay), 0.8 g self-cleaning agent (titanium dioxide nanoparticles), 90 mL first solvent (ethanol) and 10 mL water, was prepared by mixing the above components under sonication. The resulting suspension was used to treat adobe by spraying on the surface 2 times. The panels were dried before repeat the spray.
Sample 3: A suspension comprising a mixture of 0.5 g water-repellent nanoparticles (silica nanoparticles), 0.5 g nanofiller (bentonite nanoclay), 0.8 g self-cleaning agent (titanium dioxide nanoparticles), 90 mL first solvent (ethanol) and 10 mL water, was prepared by mixing the above components under sonication. The resulting suspension was used to treat adobe by spraying on the surface 2 times. The panels were dried before repeat the spray.
Sample 4: A suspension comprised a mixture of 10 mL silicon-based hydrophobic polymer (tetraethyl orthosilicate and polydimethylsiloxane), 0.5 g water-repellent nanoparticles (silica nanoparticles), 0.5 g nanofiller (bentonite nanoclay), 0.8 g self-cleaning agent (titanium dioxide nanoparticles), 90 mL first solvent (ethanol) and 10 mL water, was prepared by mixing the dispersed nano suspensions with polymer-based solution under sonication. The resulting suspension was used to treat adobe by spraying on the surface 2 times. The panels were dried before repeat the spray.
Sample 5: A suspension comprised a mixture of 10 mL silicon-based hydrophobic polymer (tetraethyl orthosilicate and polydimethylsiloxane), 0.5 g water-repellent nanoparticles (silica nanoparticles), 0.5 g nanofiller (bentonite nanoclay), 0.8 g self-cleaning agent (zinc oxide nanoparticles), 90 mL first solvent (ethanol) and 10 mL water, was prepared by mixing the dispersed nano suspensions with polymer-based solution under sonication. The resulting suspension was used to treat adobe by spraying on the surface 2 times. The panels were dried before repeat the spray.

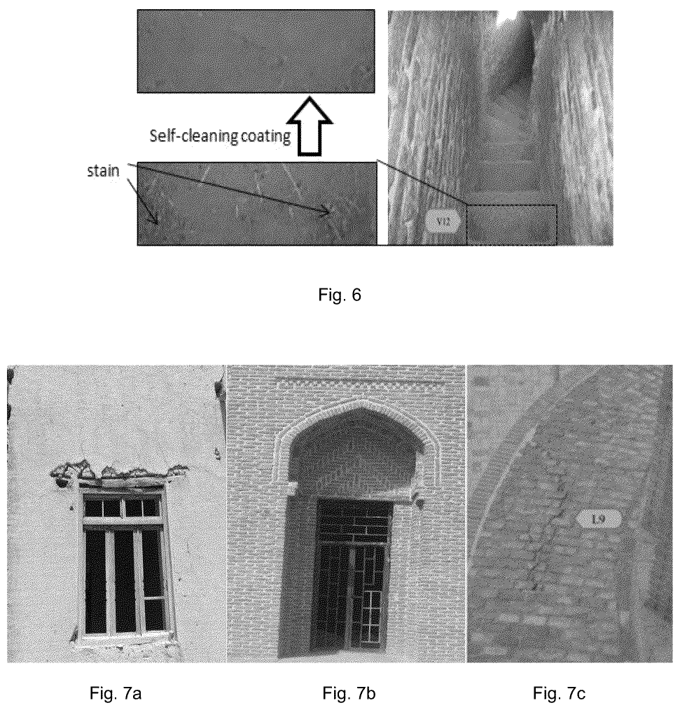

The results of stain removal were recorded in Table 3 and FIG. 6. Self-cleaning agents are the semiconductors which are activated under light irradiation and can remove the organic pollutants via oxygenated radicals produced by generated electron-holes. Table 3 show the percentage of oil stain removal from the stone surface, and FIG. 6 shows the image of untreated and treated stone with preservative coating (sample 3).

TABLE 3
Results of oil stain removal percentage

| | Sample | | | | | |
|---|---|---|---|---|---|---|
| | | Treated | | | | |
| | Untreated | Sample | Sample | Sample | Sample | Sample |
| | Sample | 1 | 2 | 3 | 4 | 5 |
| Oil stain | 0 | 99 | 97 | 97 | 95 | 94 |
| removal % | | | | | | |

### Example 4

The following describes the nanocomposite suspension preparation and coating procedure for preserving the historical building materials against fungal growth. Aspergillus niger (ATCC #6275) and Penicillium citrinum (ATCC #9849) were used for antifungal test. This experiment was conducted according to standards ASTM D3273 at 32.5° C. and 95% relative humidity for a 4 weeks period.
Sample 1: A suspension comprising a mixture of 1 g nanofiller (bentonite nanoclay), 1 g self-cleaning agent (titanium dioxide nanoparticles) and 100 mL solvents (water and ethanol with 1:9 ratio) were prepared by mixing the above chemicals under sonication. The resulting suspension was used to treat adobe by spraying on the surface 2 times. The panels were dried before repeat the spray.
Sample 2: A suspension comprising a mixture of 1 g nanofiller (bentonite nanoclay), 0.8 g self-cleaning agent (titanium dioxide nanoparticles), 5 mL vegetable oil (thyme oil), 90 mL first solvent (ethanol) and 10 mL water, was prepared by mixing the oil with dispersed nano suspensions under sonication. The resulting suspension was used to treat adobe by spraying on the surface 2 times. The panels were dried before repeat the spray.
Sample 3: A suspension comprising a mixture of 1 g nanofiller (bentonite nanoclay), 0.8 g self-cleaning agent (zinc oxide nanoparticles), 5 mL vegetable oil (thyme oil), 90 mL first solvent (ethanol) and 10 mL water, was prepared by mixing the oil with dispersed nano suspensions under sonication. The resulting suspension was used to treat adobe by spraying on the surface 2 times. The panels were dried before repeat the spray.
Sample 4: A suspension comprising a mixture of 10 mL silicon-based hydrophobic polymer (tetraethyl orthosilicate and polydimethylsiloxane), 1 g nanofiller (bentonite nanoclay), 0.8 g self-cleaning agent (titanium dioxide nanoparticles), 5 mL vegetable oil (thyme oil), 90 mL first solvent (ethanol) and 10 mL water, was prepared by mixing the dispersed nano suspensions and oil with polymer-based solution under sonication. The resulting suspension was used to treat adobe by spraying on the surface 2 times. The panels were dried before repeat the spray.
Sample 5: A suspension comprising a mixture of 10 mL silicon-based hydrophobic polymer (tetraethyl orthosilicate and polydimethylsiloxane), 0.5 g water-repellent nanoparticles (silica nanoparticles), 0.5 g nanofiller (bentonite nanoclay), 0.8 g self-cleaning agent (titanium dioxide nanoparticles), the vegetable oil (thyme oil), 90 mL first solvent (ethanol) and 10 ml water, was prepared by mixing the dispersed nano suspensions and oil with polymer-based solution under sonication. The resulting suspension was used to treat adobe by spraying on the surface 2 times. The panels were dried before repeat the spray.

The results of Aspergillus niger growth percentage were recorded below.

TABLE 4
Results of Aspergillus niger growth percentage

| | Sample | | | | | |
|---|---|---|---|---|---|---|
| | | Treated | | | | |
| | Untreated | Sample | Sample | Sample | Sample | Sample |
| | Sample | 1 | 2 | 3 | 4 | 5 |
| 1 weeks | 100 | 0 | 0 | 0 | 0 | 0 |
| 2 weeks | 100 | 0 | 0 | 0 | 0 | 0 |
| 3 weeks | 100 | 2 | 2 | 2 | 0 | 0 |
| 4 weeks | 100 | 8 | 6 | 4 | 0 | 0 |

Example 5 The following describes the preferred amounts of components in preservative nanocomposite for preserving the different historical building materials.
Sample 1: This example relates to the composition of preservative nanocomposite for protecting a historical adobe. A nanocomposite for preservation of historical adobe comprising a mixture of the 10 mL silicon-based hydrophobic agent (tetraethyl orthosilicate and polydimethylsiloxane with 1:1 ratio), 1 g water-repellent nanoparticles (silica nanoparticles), 1 g nanofiller (bentonite nanoclay), 0.8 g self-cleaning agent (titanium dioxide nanoparticles), 10 mL vegetable oil (thyme oil), 90 mL first solvent (ethanol) and 10 mL water, was prepared by mixing the dispersed nano suspensions and oil with polymer-based solution under sonication. The resulting suspension was used to treat adobe by spraying on the surface 2 times. The panels were dried before repeat the spray. The selected historical adobe contains the Quartz (SiO₂), Calcite (CaCO₃), Feldspar, Clay Mineral, and Dolomite (CaMg(CO₃)₂). After coating the adobe with this nanocomposite, the size of pores decreases to below than 20 nm, mechanical strength increases by 58% (from 107.5 to 169.7), water adsorption decreases to zero, 95% removal of oil stain and 100% removal of fungal growth.
Sample 2: This example relates to the composition of preservative nanocomposite for protecting a historical brick. A nanocomposite for preservation of historical brick comprising a mixture of the 10 mL silicon-based hydrophobic agent (tetraethyl orthosilicate and polydimethylsiloxane with 1:1 ratio), 0.8 g water-repellent nanoparticles (silica nanoparticles), 0.8 g nanofiller (bentonite nanoclay), 0.8 g self-cleaning agent (titanium dioxide nanoparticles), 10 mL vegetable oil (thyme oil), 90 mL first solvent (ethanol) and 10 mL water, was prepared by mixing the dispersed nano suspensions and oil with polymer-based solution under sonication. The resulting suspension was used to treat brick by spraying on the surface 2 times. The panels were dried before repeat the spray. The selected historical brick contains the Quartz (SiO₂), Albite (NaAlSi₃O₈), and Anorthoclase (Na_{0.85}K_{0.15}AlSi₃O₈). After coating the brick with this nanocomposite, the size of pores decreases to below than 20 nm, mechanical strength increases by 21%, water adsorption decreases to zero, 96% removal of oil stain and 100% removal of fungal growth.
Sample 3: This example relates to the composition of preservative nanocomposite for protecting a historical mortar. A nanocomposite for preservation of historical mortar comprising a mixture of the 10 mL silicon-based hydrophobic agent (tetraethyl orthosilicate and polydimethylsiloxane with 1:1 ratio), 0.8 g water-repellent nanoparticles (silica nanoparticles), 0.8 g nanofiller (bentonite nanoclay), 0.8 g self-cleaning agent (titanium dioxide nanoparticles), 10 mL vegetable oil (thyme oil), 90 mL first solvent (ethanol) and 10 mL water, was prepared by mixing the dispersed nano suspensions and oil with polymer-based solution under sonication. The resulting suspension was used to treat mortar by spraying on the surface 2 times. The panels were dried before repeat the spray. The selected historical mortar contains the Quartz (SiO₂) and Gypsum (H₄Ca₁O₆S₁). After coating the mortar with this nanocomposite, the size of cracks decreases to below than 15 nm, mechanical strength increases by 27%, water adsorption decreases to zero, 96% removal of oil stain and 100% removal of fungal growth. The images of historical buildings were displayed in FIGS. 7a-7c and the SEM images of untreated and treated samples were displayed in FIGS. 1a-1f.

What is claimed is:

1. A suspension for preserving masonry structures, comprising a hydrophobic agent, water-repellent nanoparticles, a nanofiller, a self-cleaning agent, a vegetable oil, a first solvent and water, wherein the water-repellent nanoparticles, the hydrophobic agent, the nanofiller, the self-cleaning agent and the vegetable oil are mixed with the first solvent and water, and are dispersed in a form of a nanocomposite suspension.

2. The suspension according to claim 1, wherein the suspension comprises 5-30 vol %, preferably 10-20 vol % of the hydrophobic agent, 1-10 wt %, preferably 2-3 wt % of the water-repellent nanoparticles, 1-10 wt %, preferably 2-3 wt % of the nanofillers, 1-5 wt %, preferably 1-3 wt % of the self-cleaning agent, 5-20 wt %, preferably 10 wt % of the vegetable oil, 10-30 vol %, preferably 10-20 vol % of water and 70-90 vol %, preferably 80-90 vol % of the first solvent.

3. The suspension according to claim 2, wherein the water-repellent nanoparticles includes silica nanoparticles, a silica foam, and a natural nanoporous silica including diatomaceos earth or perlite.

4. The suspension according to claim 3, wherein the silica nanoparticles have a particle size of 40-90 nm and a specific surface area of 300-350 m²/g and/or the silica foam has a specific surface area of 160-240 m²/g and/or is a natural nanoporous silica.

5. The suspension according to claim 3, wherein the natural nanoporous silica includes diatomaceos earth including 93-98% of silicon and having 87-93% porosity, and/or perlite including 75-90% of silicon and having 70-85% porosity.

6. The suspension according to claim 2, wherein the hydrophobic agent is comprising at least one silicon-based hydrophobic polymer.

7. The suspension according to claim 6, wherein the silicon-based hydrophobic polymer includes a silane, and/or silanol and/or siloxane precursors, or a derivative thereof.

8. The suspension according to claim 6, wherein the silicon-based hydrophobic polymer is selected from polydimethylsiloxane with 20-15000 MPas·s viscosity, tetramethoxysilane, tetraethoxysilane, trimethoxymethylsilane, triethoxymethylsilane, triethoxyethylsilane, dimethoxydimethylsilane, dimethoxydiethylsilane, diethoxydiethylsilane, aminopropyltrimethoxysilylane, trimethylsilanol, triethylsilanol, tris(tert-butoxy)silanol, and sodium silicate.

11. The suspension according to claim 2, wherein as the first solvent is used at least one alcohol, including ethanol and/or propanol and/or isopropanol and/or n-butanol and/or isobutanol or a mixture thereof.

12. The suspension according to claim 2, wherein the nanofillers have a particle size of 1-10 nm and a specific surface area of 120-270 m²/g, and include montmorillonite and/or bentonite and/or kaolinite nanoclays.

15. The suspension according to claim 2, wherein the nano-additive as the self-cleaning agent has a particle size of 5-50 nm and a specific surface area of 25-250 m²/g, and includes titanium dioxide and zinc oxide nanoparticles.

16. The suspension according to claim 2, wherein the vegetable oil includes linseed oil and/or soybean oil and/or olive oil and/or sunflower oil and/or thyme oil and/or oregano oil and/or clove oil.

17. A method for preserving masonry structures, especially surfaces of historical building materials as a substrate by using a multi-functional nanocomposite suspension, to increase the structures' life, improving weather-resistance and/or water-repellent and/or stain-resistance and/or fungal-resistance and/or self-cleaning, comprising the steps of:
a) selecting a structure with the substrate to be coated, wherein the substrate is a porous material;
b) preparing a suspension, wherein the suspension is prepared by mixing a water-repellent nanoparticles, at least one silicon-based hydrophobic polymer as a hydrophobic agent, a nanofiller, and/or a nano-additive as a self-cleaning agent, a vegetable oil, a first solvent and water;
c) utilizing an ultrasonic homogenizer to disperse the nanoparticles onto the nanocomposite suspension consisting of nanoparticles;
d) applying the nanocomposite suspension on the substrate at least once; and/or
e) utilizing the nanocomposite suspension to coat the substrate by using a simple spray method and/or using a blast of compressed air for a better penetration of the nanocomposite suspension into the substrate.

18. The method of claim 17, wherein said surfaces of the historical building materials such as adobe, brick, stone, and mortar are a porous material with aluminosilicate structures.
